(19) United States
(12) Patent Application Publication
(10) Pub. No.: US 2005/0175028 A1
(43) Pub. Date: Aug. 11, 2005

(54) Method for improving the quality of playback in the packet-oriented transmission of audio/video data

(76) Inventor: Bernhard Feiten, Berlin (DE)

Correspondence Address: KENYON & KENYON, ONE BROADWAY, NEW YORK, NY, 10004, US

(21) Appl. No.: 10/990,225

(22) Filed: Nov. 15, 2004

(30) Foreign Application Priority Data
Nov. 13, 2003 (DE) 10353793.7

(51) Int. Cl. H04J 3/16

(52) U.S. Cl. 370/465; 370/493

(57) ABSTRACT

Strong fluctuations of the transmission capacity may frequently occur in the transmission of audio/video signals in modern telecommunication networks. Occasionally, even breaks in transmission may occur. To improve playback, an exemplary method is provided, which may be used in GSM networks and future UMTS networks as well as for the fixed network. In scalable encoding methods for audio and video transmission, the bit stream is depacketized into a base bit stream and a defined number of enhancement bit streams. The exemplary method provides that the base bit stream, which may ensure a fully adequate playback, is transmitted with priority. Enhancement bit streams are transmitted only to the extent allowed by the available transmission bit rate in the network. The prioritized transmission of the base bit stream allows for playback to start quickly. For bridging breaks in the transmission, the base bit stream is stored in a buffer.

### CROSS-REFERENCE TO RELATED APPLICATIONS

The present application claims priority to Application No. 103 53 793.7, filed in the Federal Republic of Germany on Nov. 13, 2003, which is expressly incorporated herein in its entirety by reference thereto.

### FIELD OF THE INVENTION

The present invention relates to packet-oriented transmission of audio and video signals in communication networks.

### BACKGROUND INFORMATION

The packet-oriented data transmission in mobile telephony networks on the basis of GPRS and IP protocols may be marked by strong fluctuations of the transmission capacity. In addition, there may be occasionally longer breaks during which no data are transmitted. The delay time of the packets may be high in comparison to other transmission networks, such as, for example, fixed networks. It may be difficult to predict the quality of transmission. In GSM networks and in future UMTS networks, GPRS and IP protocols may also be used for transmitting audio and video signals.

Packet-oriented transmission may be based, for example, on the IP protocols UDP, TCP and RTP/RTCP. UDP is discussed, for example, in J. Postel: User Protocol (UDP): IETF-NWG RFC 768, 1980, 3p. TCP is discussed, for example, in J. Postel: Transmission Control Protocol (TCP): IETF-NWG RFC 793, 1981, 85p. RTP/RTCP is discussed, for example, in H. Schulzrinne, S. Casner, R. Frederick and V. Jacobson (RTP): a transport protocol for real-time applications; Request for Comments (Proposed Standard) RFC, 1889, Internet Engineering Task Force, January 1996.

Protocols, such as, for example, TCP or RTP/RTCP control the transmission via a reverse channel from the customer to the server. In the case of TCP, for example, packets that have been lost are requested once more. For RTP, different variants are specified for the payload for different audio and video codecs. The real-time transport control protocol (RTCP) that is part of RTP allows for the acquisition of data regarding the quality of the connection. The number of lost packets, the jitter and the round-trip time may be acquired. Lost packets may be requested once more. The connection may be adapted if required. For example, it may be possible to switch from a high-bit-rate codec to a low-bit-rate codec. The bit rate may not be dynamically adapted to the transmission conditions using these protocols, so that the playback of the audio/video data is permanently influenced in the case of fluctuations of the transmission capacity.

### SUMMARY

A method according to an example embodiment of the present invention for transmitting audio and video data in communication networks may allow for a qualitatively better playback even in the case of fluctuations of the transmission capacity.

An exemplary embodiment and/or exemplary method of the present invention may optimize the quality of the audio and video transmission according to three main criteria:

First, it should be possible to start playback as quickly as possible.

Second, breaks in the transmission should not result in an interruption of playback.

Third, in the case of a fluctuating transmission bit rate, the audio/video signal bit rate automatically adapts to the available transmission bit rate of the network.

The second criterion additionally entails the requirement that, in the event of a break in the transmission, the transmission channel must not be blocked with data packets, which in any case may no longer be used for correct playback.

Using scalable encoding methods for audio and video signals the bit rate may be dynamically adapted to the available channel capacity. Scalable audio and video codecs have been standardized by ISO SC29WG11 Moving Pictures Expert Group (MPEG), which is documented in ISO/IEC 14496: Coding of Audiovisual Objects, hereinafter referred to as “MPEG-4”.

Characteristic for scalable encoding methods for audio and video transmission is the feature that the bit stream is divided into a base bit stream (base layer) and a number n−1 of enhancement bit streams (enhancement layers) (see e.g., MPEG-4 Audio AAC-BSAC). The base bit stream already may ensure fully adequate audio or video playback. The quality of the transmission should be much better, the more bit streams are played back.

### BRIEF DESCRIPTION OF THE DRAWINGS

FIG. 1 shows a 16 kbit/s bit stream at a rate of transmission of 64 kbit/s.

FIG. 2 shows a 16 kbit/s bit stream at a rate of transmission of 33 kbit/s.

### DETAILED DESCRIPTION

An exemplary embodiment and/or exemplary method of the present invention may make use of a scalable audio or video bit stream. A scalable audio/video bit stream is given by a sequence of frames of the frame duration Tf. The information describing the audio or video signal within the frame may be depacketized into the base layer and the enhancement layers.

The precise composition of a frame is codec-specific. For example, a frame may be made up of several audio/video frames having a subframe duration of 20 ms. The size of the base layer and the number and increment of the enhancement layers is codec-specific. The precise composition of the frame may be irrelevant for the exemplary method described. The transmission method may be adapted to the respective encoding method. For example, the frame duration may be configured in a variable manner, which results in an additional degree of freedom. On the other hand, the size of the enhancement layers may also be adapted in a variable manner.

An exemplary embodiment and/or exemplary method of the present method defines a transmission scheme for scalable, packeted audio and video bit streams so that the base bit stream is transmitted with priority, while the enhancement bit streams are transmitted only to the extent allowed by the capacity of the transmission channel. The terminal represents the client, which is served by a server with respect to the requested audio/video stream.

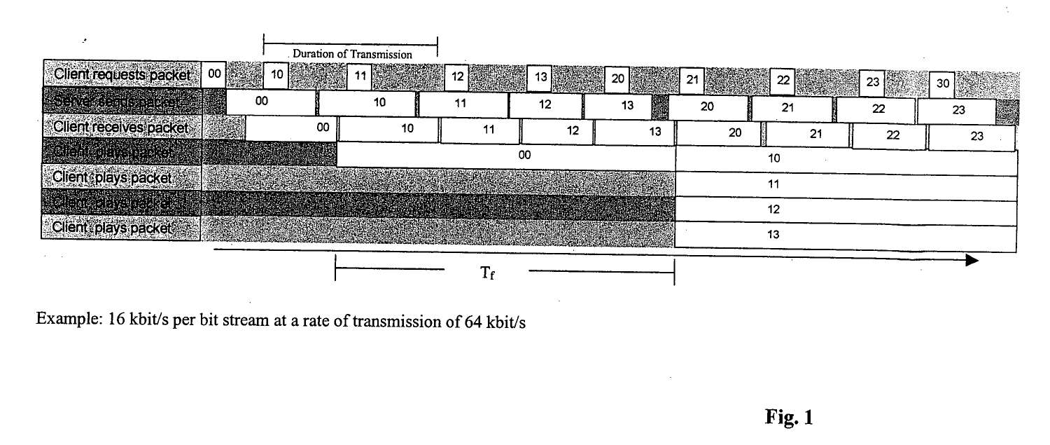

It may be characteristic for the exemplary method described that all packets are explicitly requested by the client. Following the reception of the first packet of the base bit stream, playback may begin. At the same time, the next packet of the base bit stream is requested and subsequently the number of packets of the enhancement bit streams that are possible within the scope of the available channel capacity (see FIG. 1).

A scalable audio/video bit stream may include, for example, a base bit stream and three enhancement bit streams (four partial streams) each having 16 kbit/s, and the frame may have the temporal length for a playback duration of 1 second. For example, if a transmission rate of 64 kbit/s is available, then the transmission of the base bit stream of the 0th frame takes 250 ms. Thus, the playback process may start after 250 ms and last for one second. After the reception of the 0th packet of the base bit stream has begun, the base bit stream of the 1st frame is requested. Subsequently, the enhancement bit streams of the 1st frame are requested. From the duration of the transmission it may be calculated whether all four partial streams can be transmitted.

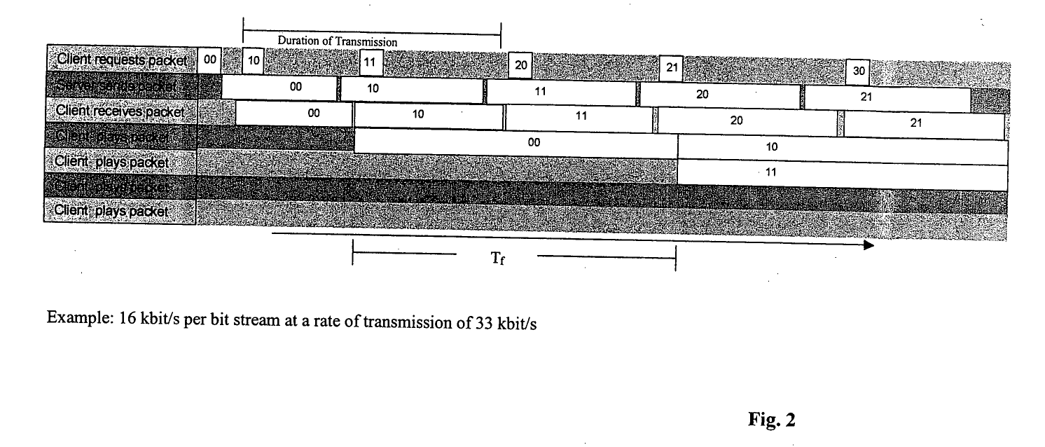

If no packets of the enhancement bit streams may be transmitted due to a limited transmission capacity (longer transmission times), then the client requests the next packet of the base bit stream and in this manner prefers the base bit stream for playback (see FIG. 2).

If, for example, the transmission of the 16 kbit/s base bit stream already takes 450 ms because the transmission rate lies only a little above 32 kbit/s, then it may be anticipated that the first enhancement bit stream may still be transmitted. The second enhancement bit stream will no longer be requested, however, the base bit stream of the 2nd frame being requested instead.

The number of the transmitted packets and hence the bit rate may thus be adapted to the available capacity of the transmission channel. Following a break in transmission, this procedure may also prevent the channel from being blocked by packets that no longer have any significance for a correct transmission. Breaks in the transmission are bridged in playback by the buffered base bit stream.

Additionally, individual packet losses of important base layers may be compensated by a renewed request (repetition request). To be sure, individual packet losses of enhancement layers result in lower playback quality, but this may be tolerable.

Burst errors may be bridged by playing back the buffered base bit stream during a break in transmission. The enhancement bit streams are not requested in this case, the base bit stream of the next frame being requested instead.

The transmission of the audio and video signals may thus be optimized so that playback may be started quickly and transmission breaks may not result in interruptions in playback. In the quick start, the subjective quality may at first limited be since only packets of the base bit stream are available. The exemplary method according to the present invention may allow for a quick-start at reduced quality. Packets of the enhancement bit streams are transmitted to the extent allowed by the capacity of the transmission route. With sufficient bandwidth of the transmission channel, the subjective quality may then deliver the full quality in the second frame. The subjective quality of playback also decreases during breaks in transmission. This may be preferable, however, to an interruption of playback.

1. A method for improving a playback quality in a packet-oriented transmission of audio/video data in at least one of GSM networks, future UMTS networks and a fixed network, on a basis of scalable encoding using a base bit stream and a defined number of enhancement bit streams, comprising:
transmitting the base bit stream with priority to allow for playback to start quickly, the base bit stream ensuring fully adequate audio/video playback;
ensuring the prioritized transmission of the base bit stream in the case of fluctuations of a transmission bit rate in the network by using a duration of the transmission of one of the base bit stream and the enhancement bit stream of a frame to calculate one of whether for a continuous playback additional enhancement bit streams of this frame is transmittable and whether the base bit stream of the next frame must already be requested, to automatically adapt the audio/video signal bit rate to an available transmission bit rate in the network;
filling a buffer on a receiver side with the base bit stream transmitted to bridge breaks in transmission from the buffer; and
preventing, in the event of breaks in the transmission, a blocking of the transmission channel by data packets that are no longer usable for correct playback.

2. The method of claim 1, further comprising:
requesting faulty bit streams once more; and
transmitting the faulty bit stream with priority.

3. The method of claim 1, further comprising:
transmitting a number of enhancement bit streams per frame and their bit rate to the available transmission bit rate in the network.
